(19) United States
(12) Patent Application Publication
(10) Pub. No.: US 2026/0199781 A1
(43) Pub. Date: Jul. 16, 2026

(54) INFORMATION PROCESSING DEVICE AND GAME IMAGE DISPLAY METHOD

(71) Applicant: Sony Interactive Entertainment Inc., Tokyo (JP)

(72) Inventors: TEIJI Yutaka, Kanagawa (JP); Toshimasa Aoki, Tokyo (JP); Shigeatsu Yoshioka, Kanagawa (JP); Akio Ohba, Kanagawa (JP); Kazuyuki Arimatsu, Tokyo (JP); Hisao Wada, Tokyo (JP)

(73) Assignee: Sony Interactive Entertainment Inc., Tokyo (JP)

(21) Appl. No.: 19/136,327

(22) PCT Filed: Dec. 15, 2022
(86) PCT No.: PCT/JP2022/046160

§ 371 Date: Jun. 6, 2025

(51) Int. Cl. A63F 13/52; A63F 13/213; A63F 13/63

(52) U.S. Cl. CPC A63F 13/52; A63F 13/213; A63F 13/63

(57) ABSTRACT

A display processing section 116 displays a play image of a first game that is generated according to a game operation performed by a user and a play image of a second game that is generated according to a game operation performed by an agent of the user. An instruction receiving section 112 receives an instruction for switching a game to be played by the user, and the display processing section 116 displays a play image of the second game that is generated according to the game operation performed by the user.

### TECHNICAL FIELD

The present disclosure relates to a technology of displaying images of a game that is being played or has been played by an agent.

### BACKGROUND ART

PTL 1 discloses a system in which an artificial intelligence (AI) character progresses a game on behalf of a user, by having a game play controller take over the game play. The game play controller trains the AI character such that the AI character simulates the play style of the user. This makes it possible to maintain the presence of the user when the AI character plays a game in a multiplayer gaming session.

### CITATION LIST

### Patent Literature [PTL 1] JP 2019-520154T

### SUMMARY

### Technical Problem

A user can progress a game by having an agent such as an AI character play the game. One object of the present disclosure is to provide a technology of displaying on a display device play images of a game that is being played or has been played by an agent.

### Technical Solution

In order to solve the problem described above, an information processing device according to a mode of the present disclosure includes one or more processors including hardware, in which the one or more processors display a play image of a first game that is generated according to a game operation performed by a user and display a play image of a second game that is generated according to a game operation performed by an agent of the user.

A game image display method according to another mode of the present disclosure is a method of displaying a play image of a game in an information processing device, the method including displaying a play image of a first game that is generated according to a game operation performed by a user and displaying a play image of a second game that is generated according to a game operation performed by an agent of the user.

Note that any combination of the abovementioned constituent elements and expressions of the present disclosure converted between methods, devices, systems, recording media, computer programs, and the like are also effective as the modes of the present disclosure.

### BRIEF DESCRIPTION OF DRAWINGS

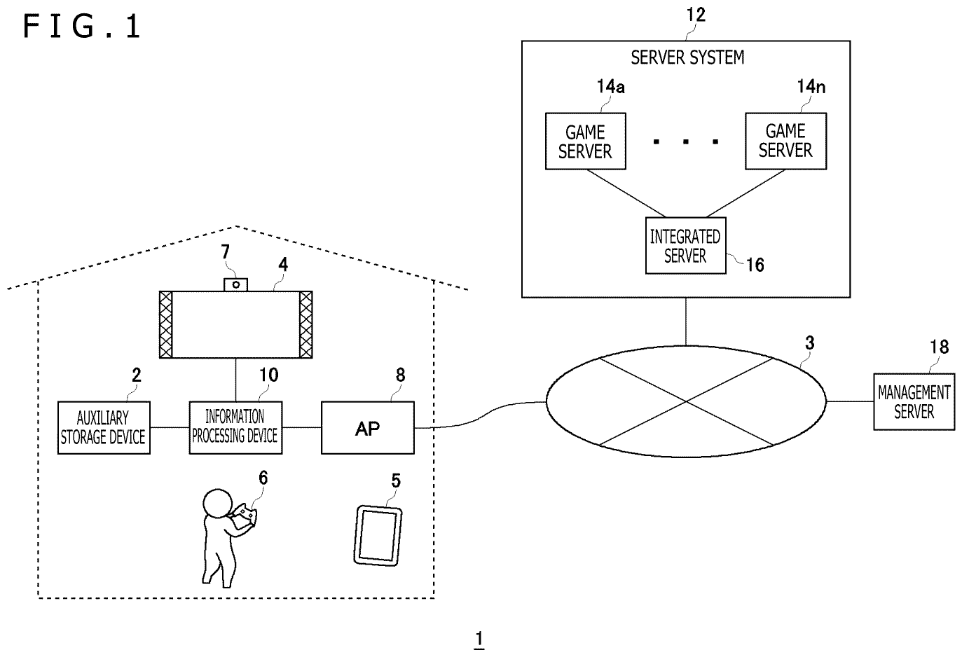

### FIG. 1 is a view illustrating an information processing system according to an embodiment.

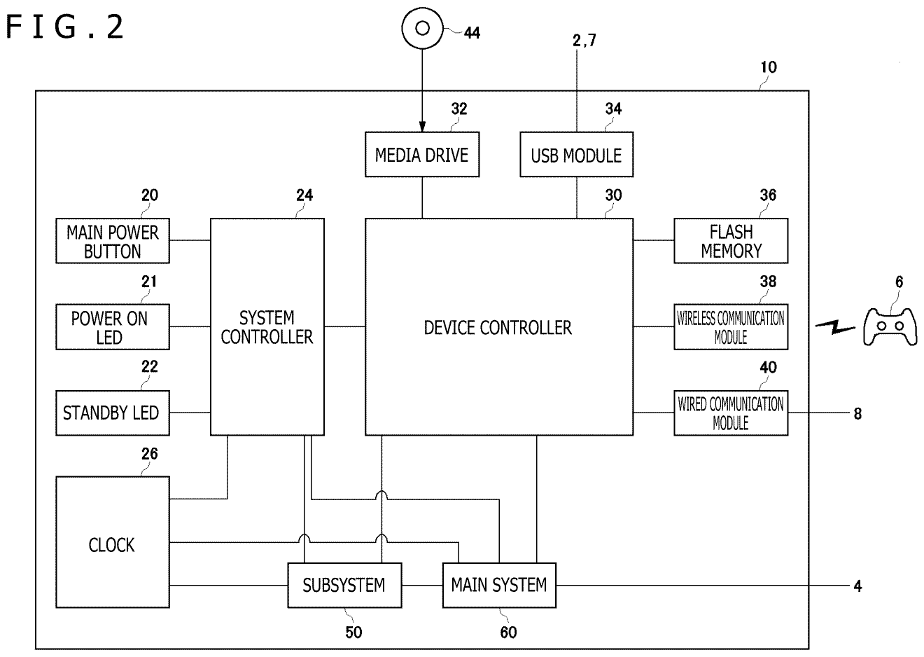

FIG. 2 is a view illustrating a hardware configuration of an information processing device.

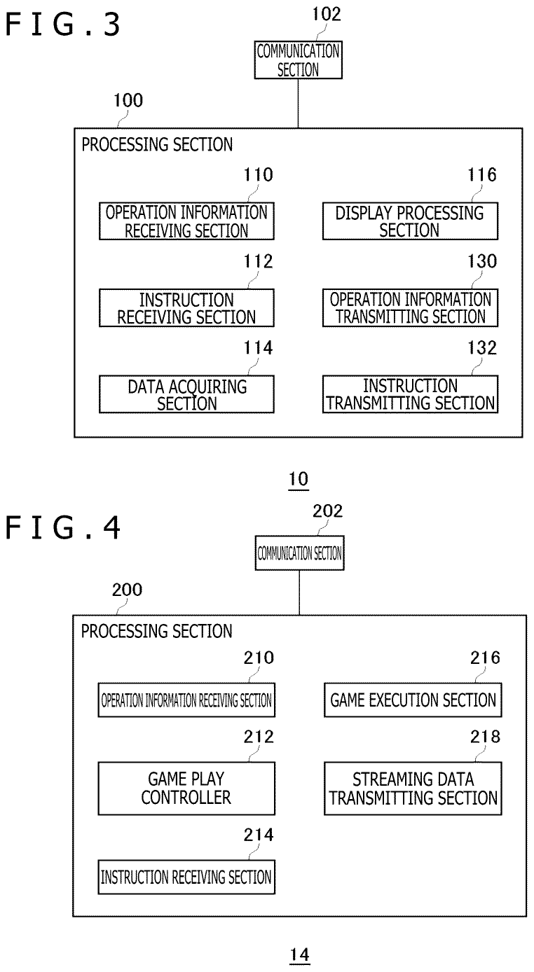

FIG. 3 is a view illustrating functional blocks of the information processing device.

FIG. 4 is a view illustrating functional blocks of a game server.

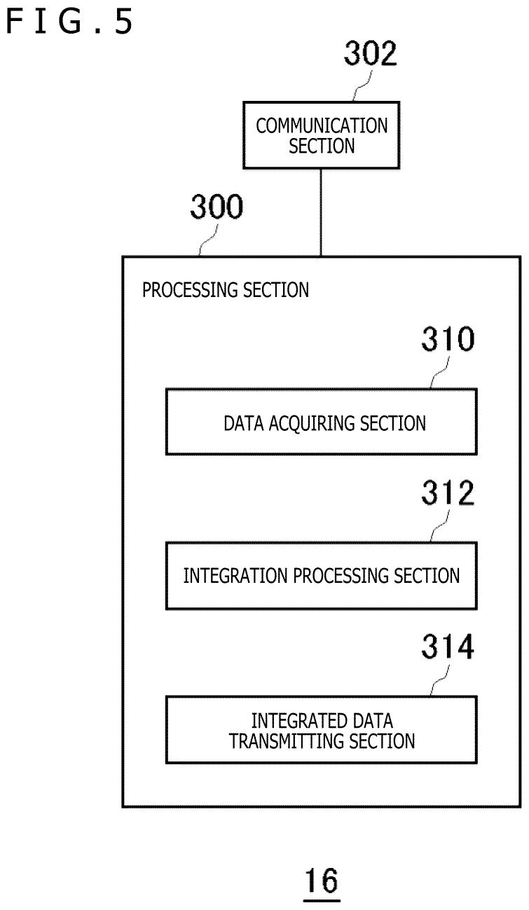

FIG. 5 is a view illustrating functional blocks of an integrated server.

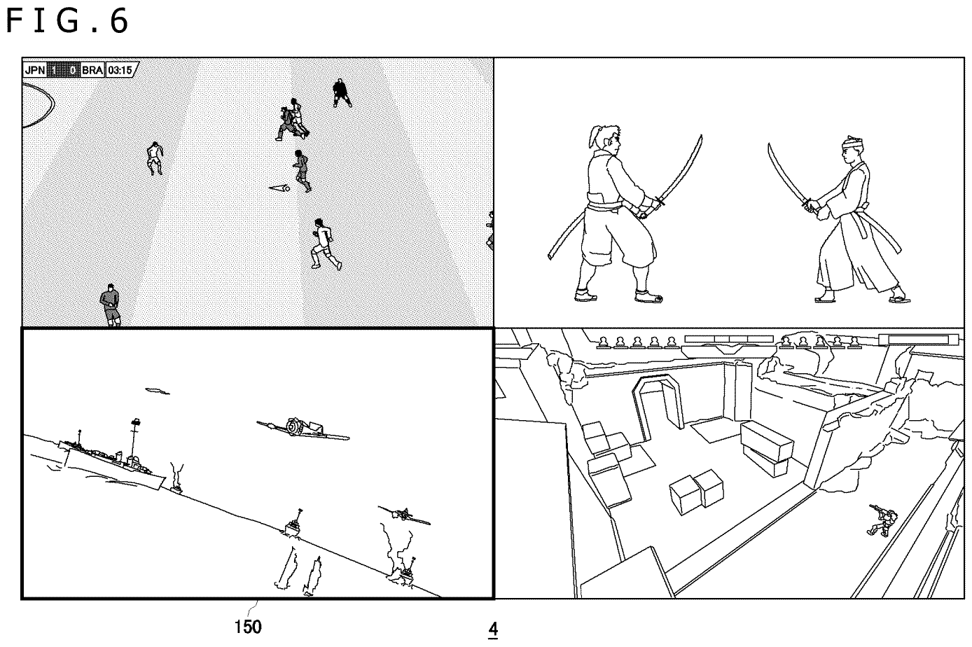

FIG. 6 is a view illustrating an example of a plurality of play images.

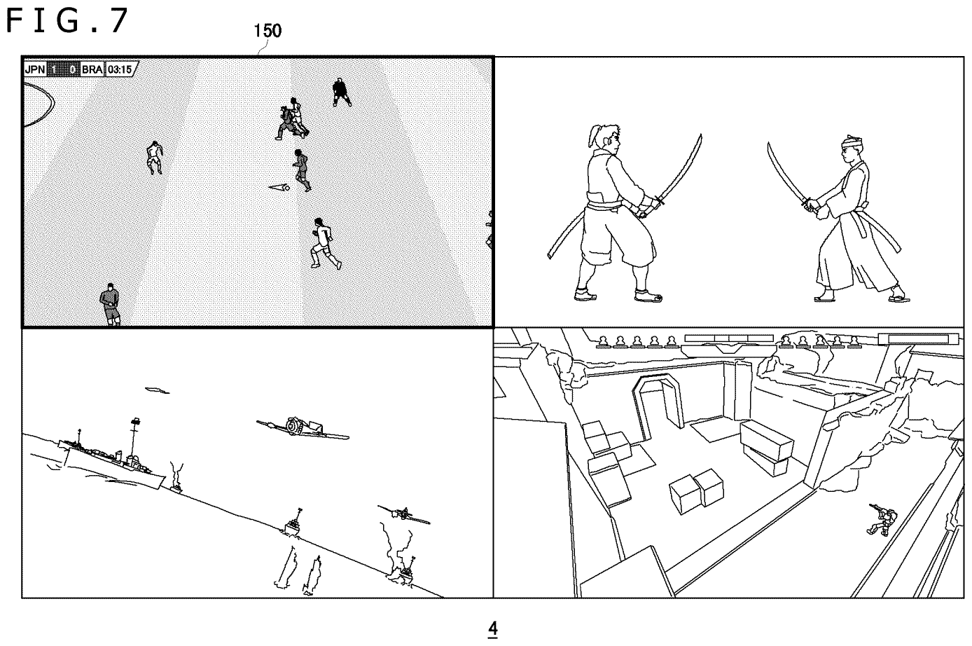

FIG. 7 is a view illustrating an example of a plurality of play images.

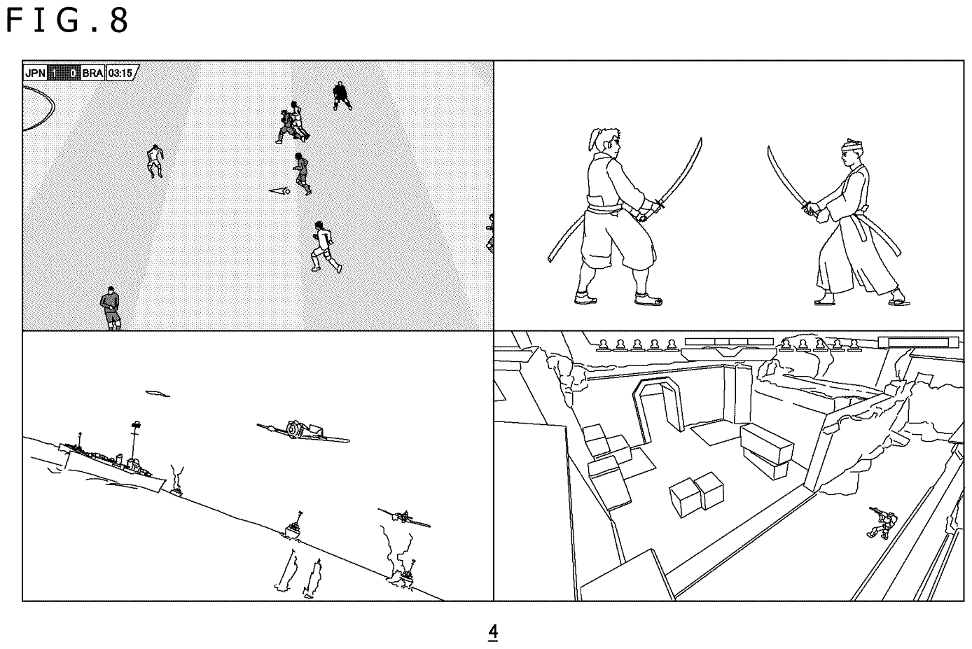

FIG. 8 is a view illustrating an example of a plurality of play images.

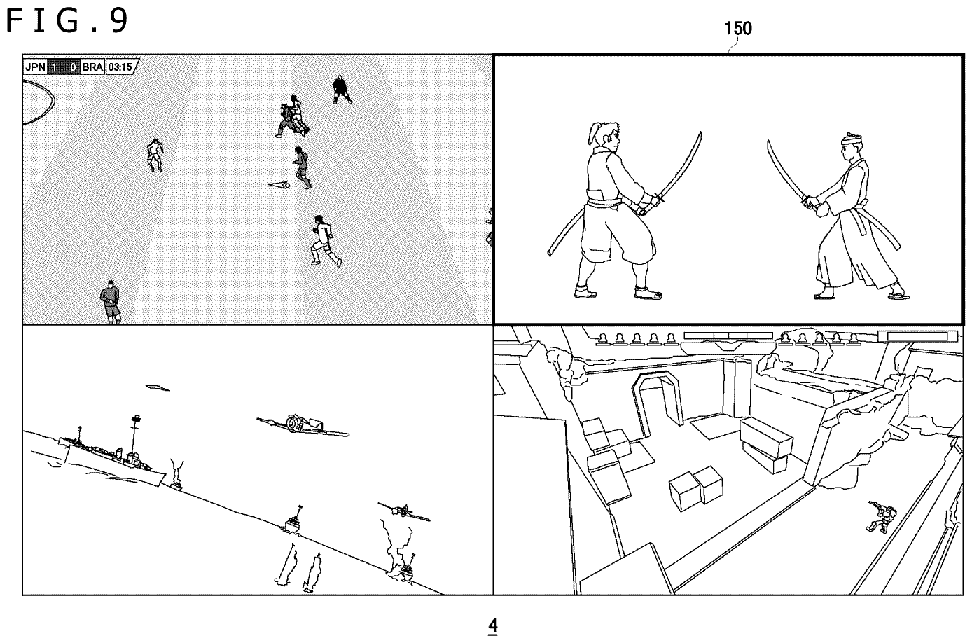

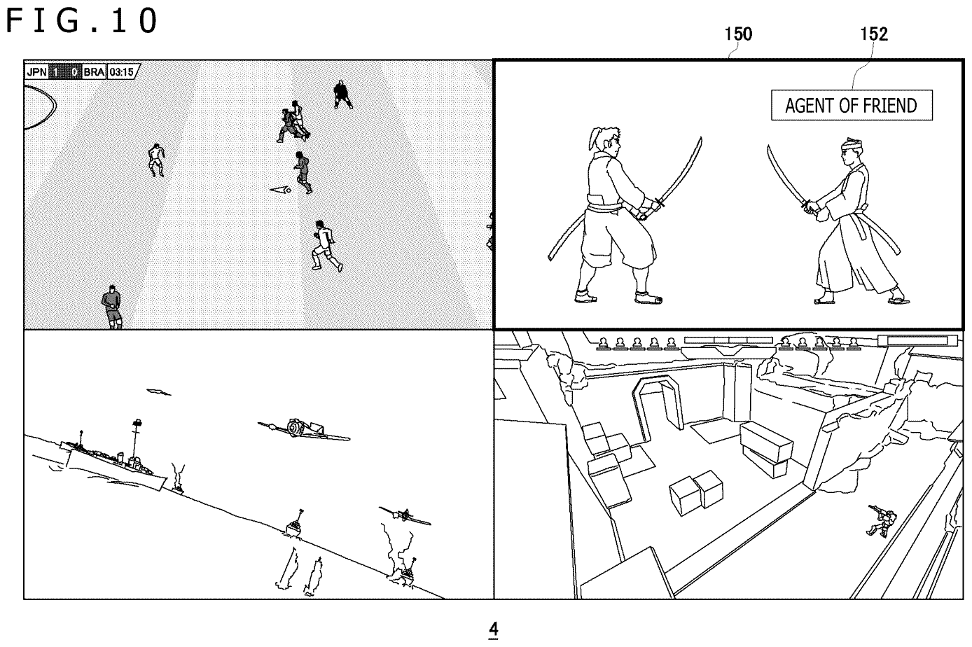

FIG. 9 is a view illustrating an example of a plurality of play images.

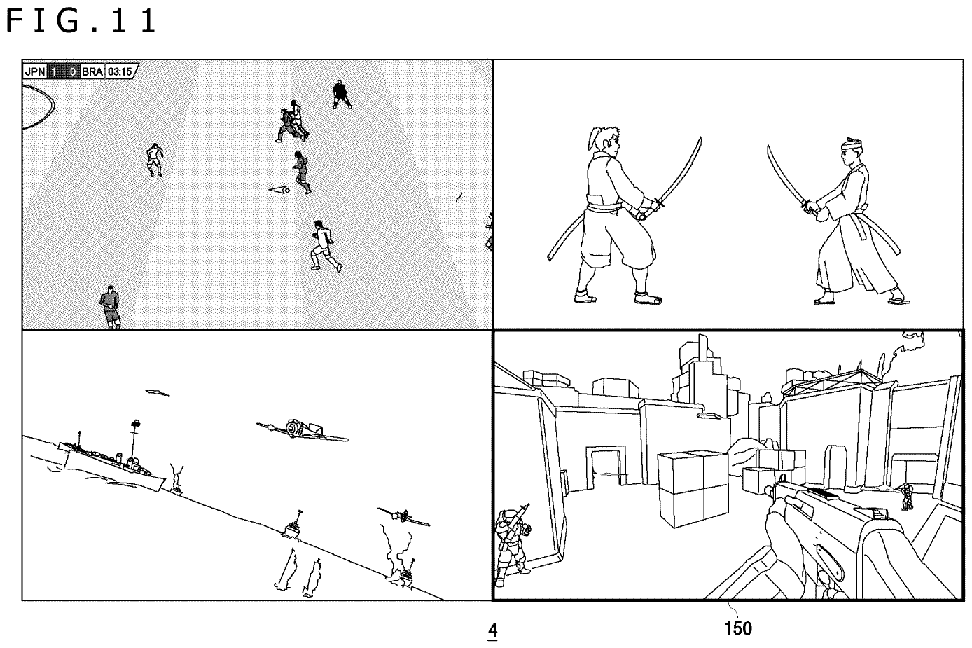

FIG. 10 is a view illustrating an example of a plurality of play images.

FIG. 11 is a view illustrating an example of a plurality of play images.

### DESCRIPTION OF EMBODIMENT

FIG. 1 illustrates an information processing system 1 according to an embodiment of the present disclosure. The information processing system 1 includes an information processing device 10 operated by a user, a server system 12, and a management Server 18. These components are connected to one another via a network 3 that is, for example, the Internet or a local area network (LAN). An access point (hereinafter also referred to as an “AP”) 8 has the functions of a wireless access point and a router, and the information processing device 10 connects to the AP 8 in a wireless or wired manner and connects to the management server 18 and the server system 12 on the network 3 such that communication can be performed therewith.

The information processing device 10 connects, in a wireless or wired manner, to an input device 6 operated by a user, and the input device 6 supplies information concerning an operation performed by the user to the information processing device 10. The information processing device 10, upon receiving operation information from the input device 6, reflects the information in the processing in system software and application software and causes the processing result to be output from an output device 4. The input device 6 may be a device that supplies the user operation information to the information processing device 10, as exemplified by a game controller, or may be an input interface such as a keyboard or a mouse.

The output device 4 may be a television set including a display device for outputting images and a speaker for outputting sounds or a computer display. The output device 4 may be connected to the information processing device 10 by a wired cable or in a wireless manner. A terminal device 5 may be a portable terminal device including a display device and a speaker, as exemplified by a smartphone and a tablet device, or may alternatively be a stationary terminal device including a display device and a speaker. The terminal device 5 may be connected to the information processing device 10 by a wired cable or in a wireless manner.

An auxiliary storage device 2 is a storage unit such as a hard disk drive (HDD) or a solid-state drive (SSD). The auxiliary storage device 2 may be a built-in storage device or an external storage device that is connected to the information processing device 10 by a universal serial bus (USB), for example. A camera 7 which is an imaging device is provided in the vicinity of the output device 4 and images a space around the output device 4. While the camera 7 is illustrated in FIG. 1 as being attached to an upper portion of the output device 4, the camera 7 may instead be disposed on a side portion or a lower portion of the output device 4; in either case, the camera 7 is disposed at a position where a user positioned in front of the output device 4 can be imaged. The camera 7 may be a stereo camera. The images captured by the camera 7 may be used for detecting a line of sight of the user.

In the information processing system 1, the management server 18 provides a network service to the information processing device 10. The management server 18 manages network accounts for identifying users, and each user uses the network account to sign in to the network service. By signing in to the network service, users can use a cloud gaming service provided by the server system 12.

The server system 12 includes a plurality of game servers 14a, . . . and 14n (hereinafter simply referred to as the “game servers 14” when the game servers are not particularly distinguished from one another) and an integrated server 16 and builds a cloud gaming system. The plurality of game servers 14 execute game programs of different types, and thus, the users can enjoy a plurality of types of cloud games. Each of the game servers 14 may be maintained and managed by an entity operating each cloud gaming service.

When the user operates the input device 6 while playing a game, the information processing device 10 provides information concerning a game operation to the game server 14 via the network 3. The information concerning a game operation may be provided to the game server 14 via the integrated server 16 but may alternatively directly be provided to the game server 14 without being routed through the integrated server 16. The game server 14, upon receiving the information concerning the game operation performed by the user, executes a game program by using the operation information and generates play images and play sounds of the game. Note that, in the following description, the play images and the play sounds generated by the game server 14 are simply referred to as the “play images” for the convenience of description. In the embodiment, the play images generated by the game server 14 are streamed to the information processing device 10 via the integrated server 16. As will be described later, the integrated server 16 integrates a plurality of play images generated by the plurality of game servers 14 and streams the integrated play images to the information processing device 10. The information processing device 10 outputs the plurality of streamed play images from the output device 4.

In the information processing system 1 according to the embodiment, the user can have an agent play the game on behalf of the user him/herself. While the agent is playing the game, the user performs no game operation for the game. The user can leave the operation of the game the user is playing to the agent in the middle of the game operation, or alternatively have the agent perform the game operation from the beginning. The user can also take over the operation of the game being played by the agent in the middle of the game operation.

The agent according to the embodiment may be an AI agent (AI character) that performs game play by following the play style and skills (proficiency) of the user through machine learning of the details of the game play performed by the user in the past. With the agent having the play style and skills that are the same as or similar to those of the user, progress in the game by the agent can be made similar to the progress made when the user actually plays the game. Moreover, when the agent plays the game with a user's friend, the friend can have a feeling as if he/she were actually playing the game with the user.

The agent may be a bot that is provided by the game. For example, when the game provides a plurality of types of bots having different play styles and skills, the user may select one bot, and the selected bot may play the game on behalf of the user. Note that, if the game side can assess the play style and skills of the user, a bot that matches the play style and skills of the user can automatically be selected. In either case, the agent according to the embodiment can autonomously play a game and progress the game on behalf of the user. As described above, the user may have the agent play the game and then play the game him/herself by taking over the game play at a desired timing.

An agent that autonomously plays the game is implemented by the game play controller. The game play controller according to the embodiment is provided in the game server 14, and the agent generates a command according to the state of progress in the game and supplies the generated command to the game. The agent may generate operation information concerning the input device 6 that corresponds to a command and supply the operation information to the game. Note that the game play controller may be provided in the information processing device 10 and supply the command for the game to the game server 14 via the network 3.

FIG. 2 illustrates a hardware configuration of the information processing device 10. The information processing device 10 includes a main power button 20, a power ON light emitting diode (LED) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main central processing unit (CPU), a memory that is a main storage device, a memory controller, a graphics processing unit (GPU), and the like. The GPU is mainly used for arithmetic processing for a game program. The main CPU has a function of activating an operating system (OS) and executing game programs installed in the auxiliary storage device 2, under the environment provided by the OS. The subsystem 50 includes a sub-CPU, a memory that is a main storage device, a memory controller, and the like, but not the GPU.

While the main CPU has the function of executing the game programs installed in the auxiliary storage device 2 and a read only memory (ROM) medium 44, the sub-CPU has no such function. However, the sub-CPU has the function of accessing the auxiliary storage device 2 and the function of transmitting and receiving data to and from the management server 18. The sub-CPU has only such limited processing functions and can thus operate with smaller power consumption than the main CPU. These functions of the sub-CPU are executed when the main CPU is in a standby state.

The main power button 20 is an input section in which an operation input is performed by the user, is provided on a front surface of a housing of the information processing device 10, and is operated to turn on or off the power supply to the main system 60 of the information processing device 10. The power ON LED 21 is lit when the main power button 20 is turned on, and the standby LED 22 is lit when the main power button 20 is turned off. The System controller 24 detects that the main power button 20 is being pressed down by the user.

The clock 26 is a real time clock, generates current date and time information, and supplies the current date and time information to the system controller 24, the subsystem 50, and the main system 60.

The device controller 30 is configured as a large-scale integrated circuit (LSI) that exchanges information between devices like a southbridge. As illustrated in FIG. 2, devices including the system controller 24, the media drive 32, the USB module 34, the flash memory 36, the wireless communication module 38, the wired communication module 40, the subsystem 50, and the main system 60 are connected to the device controller 30. The device controller 30 absorbs the difference in electronic properties and the difference in data transfer speed among the devices and controls the timing of data transfer.

The media drive 32 is a drive device that drives with the ROM medium 44, in which application software such as a game and license information are recorded, being mounted thereon and reads out programs and data from the ROM medium 44. The ROM medium 44 is a read only recording medium such as an optical disk, a magneto-optical disk, and a Blu-ray disk.

The USB module 34 is a module connected to an external device by a USB cable. The USB module 34 may be connected to the auxiliary storage device 2 and the camera 7 by a USB cable. The flash memory 36 is an auxiliary storage device configuring internal storage. The wireless communication module 38 is a communication protocol as exemplified by a Bluetooth (registered trademark) protocol and an Institute of Electrical and Electronics Engineers (IEEE) 802.11 protocol and, for example, wirelessly communicates with the input device 6. The wired communication module 40 performs wired communication with an external device and connects to the network 3 via the AP 8, for example.

FIG. 3 illustrates functional blocks of the information processing device 10. The information processing device 10 according to the embodiment includes a processing section 100 and a communication section 102 and has the function of simultaneously displaying play images of a plurality of games on the output device 4. Note that, in the embodiment, the “play image” refers to a display image of a game that is being played or has been played by the user or the agent of the user, and the information processing device 10 simultaneously displays, on the output device 4, a plurality of play images that are transmitted from the integrated server 16. The processing section 100 £ includes an operation information receiving section 110, an instruction receiving section 112, a data acquiring section 114, a display processing section 116, an operation information transmitting section 130, and an instruction transmitting section 132.

The information processing device 10 includes a computer which executes programs to implement various kinds of functions illustrated in FIG. 3. The computer includes, as hardware, a memory for loading a program, one or more processors for executing the loaded program, an auxiliary storage device, and other LSIs, for example. The processor is configured by a plurality of electronic circuits including semiconductor integrated circuits (ICs) and LSIS. The plurality of electronic circuits may be mounted on a single chip or a plurality of chips. The functional blocks illustrated in FIG. 3 are implemented by cooperation between hardware and software, and hence, a person skilled in the art would recognize that these functional blocks can be implemented in various forms including hardware alone, software alone, or a combination of the two.

The communication section 102 receives operation information concerning an operation performed by the user on the input section of the input device 6 and supplies the operation information to the operation information receiving section 110. Further, the communication section 102 communicates with the management server 18, the game server 14, and the integrated server 16 and transmits and receives various kinds of information or data. The communication section 102 may have the functions of both the wireless communication module 38 and the wired communication module 40.

In the embodiment, the user accesses the game server 14 that provides the game which the user him/herself is to play and starts the game play. When the user operates the input device 6 while playing the game, the operation information receiving section 110 receives the game operation information, and the operation information transmitting section 130 transmits the operation information to the game server 14 via the communication section 102.

Further, the user accesses the game server 14 that provides the game which the user has the agent play and requests that the agent play the game. The game server 14, upon receiving this request, activates the agent of the user, and the agent of the user generates a command according to the state of progress in the game. As described above, in the embodiment, the user plays a game provided by one of the game servers 14 and also has the agent of the user play a game or games provided by one or more different game servers 14.

FIG. 4 illustrates functional blocks of the game server 14. The game server 14 according to the present embodiment includes a processing section 200 and a communication section 202 and has the function of progressing a game by executing a game program according to user operation information or a command (which may also be operation information) from the agent. The processing section 200 includes an operation information receiving section 210, a game play controller 212, an instruction receiving section 214, a game execution section 216, and a streaming data transmitting section 218. The game play controller 212 activates the agent of the user and generates a game command corresponding to the scene.

The game server 14 includes a computer which executes programs to implement various kinds of functions illustrated in FIG. 4. The computer includes, as hardware, a memory for loading a program, one or more processors for executing the loaded program, an auxiliary storage device, and other LSIs, for example. The processor is configured by a plurality of electronic circuits including semiconductor ICs and LSIs. The plurality of electronic circuits may be mounted on a single chip or a plurality of chips. The functional blocks illustrated in FIG. 4 are implemented by cooperation between hardware and software, and hence, a person skilled in the art would recognize that these functional blocks can be implemented in various forms including hardware alone, software alone, and a combination of the two.

In the game server 14, the game execution section 216 executes a game program in accordance with user operation information or a command from the agent. When the user is playing a game, the operation information receiving section 210, upon receiving the user operation information, supplies the user operation information to the game execution section 216, which performs arithmetic processing of moving a player character in a virtual space in reference to the operation information. The game execution section 216 includes a GPU and generates game image data obtained from a viewpoint position in the virtual space (virtual camera), in response to the result of arithmetic processing performed in the virtual space. Further, the game execution section 216 generates game sound data obtained from the viewpoint position in the virtual space.

Further, when the agent is to play the game, the game play controller 212 activates the agent, which generates a command according to the state of progress in the game and supplies the command to the game execution section 216. The game execution section 216 performs arithmetic processing of moving the player character in a virtual space in accordance with the command generated by the agent. As described above, the game execution section 216 generates game image data and game sound data obtained from the viewpoint position in the virtual space (virtual camera).

The streaming data transmitting section 218 transmits streaming data including the game image data and the game sound data, together with the network account of the user, to the integrated server 16. The streaming data transmitting section 218 may also transmit player information indicating whether the player of the game is the user or the agent to the integrated server 16. The integrated server 16 has the role of receiving the streaming data from the plurality of game servers 14 and integrating the plurality of pieces of streaming data directed to the same user.

FIG. 5 illustrates functional blocks of the integrated server 16. The integrated server 16 according to the embodiment includes a processing section 300 and a communication section 302 and has the function of integrating pieces of streaming data generated by the plurality of game servers 14. Here, “integrate” refers to processing of combining a plurality of pieces of streaming data directed to the same user into one or more pieces of streaming data. In the embodiment, the integrated server 16 combines a plurality of pieces of streaming data directed to the same user into one piece of streaming date, but in a modification, the integrated server 16 may combine the plurality of pieces of streaming data directed to the same user into two or more pieces of streaming data. The processing section 300 includes a data acquiring section 310, an integration processing section 312, and an integrated data transmitting section 314.

The integrated server 16 includes a computer which executes programs to implement various kinds of functions illustrated in FIG. 5. The computer includes, as hardware, a memory for loading a program, one or more processors for executing the loaded program, an auxiliary storage device, and other LSIs, for example. The processor is configured by a plurality of electronic circuits including semiconductor ICs and LSIs, and the plurality of electronic circuits may be mounted on a single chip or a plurality of chips. The functional blocks illustrated in FIG. 5 are implemented by cooperation between hardware and software, and hence, a person skilled in the art would recognize that these functional blocks are implemented in various forms including hardware alone, software alone, and a combination of the two.

The data acquiring section 310 acquires streaming data generated by the plurality of game servers 14. The network account of the user is added to the streaming data, and the integration processing section 312 refers to the added network account and combines the plurality of pieces of streaming data for each user. Specifically, the integration processing section 312 integrates the plurality of pieces of streaming data such that the plurality of pieces of streaming data can be displayed on one display device in the information processing device 10. The integrated data transmitting section 314 transmits the integrated streaming data to the information processing device 10 of the user.

In the following description, explanation will be given on the display processing of the play images performed when the user has the agent play three games while playing one game by him/herself.

FIG. 6 illustrates an example of a plurality of play images displayed on the output device 4. In the information processing device 10, the data acquiring section 114 acquires from the integrated server 16 streaming data obtained by integrating play images of a plurality of games. The display processing section 116 displays the play images of a plurality of games on the output device 4.

In a screen example illustrated in FIG. 6, the display processing section 116 divides a display area of the output device 4 into four and displays play images of four games. Here, the display processing section 116 displays a play image of a battleship game that is generated according to a game operation performed by the user, in a lower left display area, and displays play images of games that are generated according to game operations performed by the agent of the user, in upper left, upper right, and lower right display areas.

The display processing section 116 may display the play image of the game operated by the user, in a first mode, and display the play images of the games operated by the agent, in a second mode different from the first mode. In the example illustrated in FIG. 6, a frame 150 is displayed around the play image of the battleship game operated by the user, to clearly indicate that the play image displayed in the lower left display area is the image of the game operated by the user. According to the embodiment, since play images of a plurality of games are displayed simultaneously on the output device 4, it is preferable that the relevant image be clearly indicated as being the play image of the game operated by the user to allow the user to make no mistake in recognizing the play image of the game he/she is operating.

The display processing section 116 may display the play images of the games operated by the agent with the resolution lowered than that of the play image of the game operated by the user. Alternatively, the display processing section 116 may make the screen size of the play images of the games operated by the agent smaller than that of the play image of the game operated by the user. Still alternatively, the display processing section 116 may reduce the brightness of the play images of the games operated by the agent, compared to that of the play image of the game operated by the user. In this manner, the display processing section 116 makes the mode of displaying the play images of the games operated by the agent different from that for the play image of the game operated by the user, so that the user can easily recognize the play image of the game he/she is operating.

In the integrated server 16, the integration processing section 312 generates integrated data in which a plurality of play images are integrated, in such a manner that the play image of the game operated by the user is displayed in the first mode on the output device 4 and the play images of the games operated by the agent are displayed in the second mode on the output device 4. Thus, when the display processing section 116 displays the integrated data on the output device 4, the play image of the game operated by the user is displayed in the first mode, and the play images of the games operated by the agent are displayed in the second mode.

In the display screen illustrated in FIG. 6, the user is playing the battleship game by operating the input device 6 while looking at the play image displayed in the lower left area. The user can simultaneously look at the images of different games played by the agent, while playing the battleship game. Thus, the user can easily check the state of the games that are played by the agent. For example, when looking at the state of a soccer game played by the agent, the user may sometimes be tempted to play the soccer game, and in such a case, it is preferable that the user be allowed to switch the game he/she is playing to another desired game.

The user may be able to operate the input device 6 and input an instruction for switching the game to play to the information processing device 10. For example, when the user selects the game he/she wants to play from a menu screen displaying a list of game titles being played, the instruction receiving section 112 receives the instruction for switching the game to play, and the instruction transmitting section 132 transmits the switching instruction to each of the game server 14 for the battleship game that the user is currently playing and the game server 14 for the soccer game that the user is going to play. Here, the instruction transmitting section 132 transmits the switching instruction indicating that the player is to be switched from the user to the agent to the game server 14 for the battleship game and the switching instruction indicating that the player is to be switched from the agent to the user to the game server 14 for the soccer game.

Described with reference to FIG. 4, in the game server 14 for the battleship game, when the instruction receiving section 214 receives the switching instruction indicating that the player is to be switched from the user to the agent, the game play controller 212 activates the agent of the user. Thus, in the game server 14 for the battleship game, the agent becomes the player by the switching instruction and generates a command for the battleship game, and the game execution section 216 generates play images according to the game operation performed by the agent. The streaming data transmitting section 218 transmits streaming data including the play images, together with the network account of the user and the player information indicating that the player is the agent, to the integrated server 16.

Meanwhile, in the game server 14 for the soccer game, when the instruction receiving section 214 receives the switching instruction indicating that the player is to be switched from the agent to the user, the game play controller 212 ends the operation of the agent of the user, and the game execution section 216 generates play images according to the game operation performed by the user. The streaming data transmitting section 218 transmits streaming data including the play images, together with the network account of the user and the player information indicating that the player is the user, to the integrated server 16.

Described with reference to FIG. 5, in the integrated server 16, the integration processing section 312 refers to the network account added to the streaming data and the player information, to generate the integrated data in which a plurality of pieces of streaming data are integrated. At this time, the integration processing section 312 adds the frame 150 to the play image of the soccer game by recognizing from the player information that the user is playing the soccer game. The integrated data transmitting section 314 transmits the integrated streaming data to the information processing device 10 of the user.

FIG. 7 illustrates an example of a plurality of play images displayed on the output device 4. In the information processing device 10, the data acquiring section 114 acquires from the integrated server 16 streaming data in which the play images of a plurality of games are integrated. The display processing section 116 displays the play images of the plurality of games on the output device 4. Compared to the example illustrated in FIG. 6, the display processing section 116 displays the play image of the soccer game that is generated according to the game operation performed by the user, in the upper left area, while displaying the play image of the battleship game that is generated according to the game operation performed by the agent, in the lower left area. Around the play image generated according to the game operation performed by the user, the frame 150 is displayed.

The user may operate the input device 6 and input an instruction for switching the game to play to the information processing device 10, but, for example, the user may instead use his/her line of sight to input the instruction for switching the game to play to the information processing device 10. In recent years, a technology called eye tracking that measures the motion of an eyeball relative to the head and tracks the place where the user is looking at has come to widespread use. This technology may be used for the instruction receiving section 112 to detect the line of sight of the user, identify the display area the user is looking at from among the display areas divided in the output device 4, and receive the switching instruction for the game to be played by the user.

As described above, the user can input the instruction for switching the game to play to the information processing device 10, but the user may sometimes wish to leave the operation of the game the user is currently playing to the agent. In this case, the user may input a player change instruction for having the agent perform the operation of the game the user is currently playing to the information processing device 10.

When the user operates the input device 6 and inputs a player change instruction for having the agent operate the game, the instruction receiving section 112 receives the player change instruction, and the instruction transmitting section 132 transmits the player change instruction to the game server 14 for the soccer game currently being played by the user. Described with reference to FIG. 4, in the game server 14 for the soccer game, when the instruction receiving section 214 receives the player change instruction for having the agent operate the game, the game play controller 212 activates the agent of the user. In this manner, in the game server 14 providing the soccer game, with the player change instruction being provided, the agent becomes the player and generates a command for the soccer game, and the game execution section 216 generates play images according to the game operation performed by the agent. The streaming data transmitting section 218 transmits the streaming data including the play images, together with the network account of the user and the player information indicating that the player is the agent, to the integrated server 16.

FIG. 8 illustrates an example of a plurality of play images displayed on the output device 4. In this instance, the agent is performing the game operation for all of the games, and the user is performing no game operation; hence, the frame 150 is not added to the play image. Note that the user may operate the input device 6 and input the player change instruction for the user to perform the game operation. For example, when the user inputs the player change instruction for the user to operate a samurai game displayed in the upper right area, the instruction receiving section 112 receives the player change instruction, and the instruction transmitting section 132 transmits the player change instruction to the game server 14 for the samurai game.

Described with reference to FIG. 4, in the game server 14 for the samurai game, when the instruction receiving section 214 receives the player change instruction for the user to perform the game operation, the game play controller 212 ends the operation of the agent of the user, and the game execution section 216 generates the play images according to the game operation performed by the user. At this time, the streaming data transmitting section 218 transmits the streaming data including the play images, together with the network account of the user and the player information indicating that the player is the user, to the integrated server 16.

In the integrated server 16, the integration processing section 312 recognizes from the player information that the user is playing the samurai game, and adds the frame 150 to the play image of the samurai game. The integrated data transmitting section 314 transmits the integrated streaming data to the information processing device 10 of the user.

FIG. 9 illustrates an example of a plurality of play images displayed on the output device 4. In the information processing device 10, the data acquiring section 114 acquires the streaming data in which play images of a plurality of game images are integrated from the integrated server 16. The display processing section 116 displays the play images of the plurality of games on the output device 4. Compared to the example illustrated in FIG. 8, the display processing section 116 displays the play image of the samurai game that is generated according to the game operation performed by the user, in the upper right area, in a state in which the frame 150 is added.

In the embodiment, an environment in which the user can have the agent play a game is realized, and hence, the user may play a game with an agent of another user (for example, a friend) in some cases.

FIG. 10 illustrates an example of a plurality of play images displayed on the output device 4. In this example, the play image of the samurai game displayed in the upper right area includes additional information 152 indicating that the enemy character is operated by an agent of a friend. In the integrated server 16, the integration processing section 312 may dispose the additional information 152 indicating that the agent of the friend is operating the game, in the vicinity of the character operated by the agent of the friend. This allows the user to recognize that the opponent is the agent of the friend.

In the game screen illustrated in FIG. 10, a play image of a shooting game is displayed in the lower right area. The game server 14 providing the shooting game may generate, when the game is executed according to a game operation performed by the user, a play image based on a first viewpoint, and generate, when the game is executed according to a game operation performed by the agent, a play image based on a second viewpoint different from the first viewpoint. In the game screen illustrated in FIG. 10, the shooting game is operated by the agent, and a play image based on a bird's eye viewpoint is displayed in the lower right area.

FIG. 11 illustrates an example of a plurality of play images displayed on the output device 4. In this example, the user is operating the shooting game, and hence, the frame 150 is added around the play image of the shooting game that is displayed in the lower right area. Compared to the example illustrated in FIG. 10, a play image based on a first-person viewpoint is displayed in the lower right area. In this manner, the game server 14 generates play images based on different viewpoints depending on whether the player is the user or the agent. This allows the user to easily determine whether or not the user him/herself is the player by simply looking at the play images.

The display processing section 116 may display the play image of the game for which a game operation by the user is recommended, in a mode different from those for other play images. Note that the game for which a game operation by the user is to be recommended is limited to the games being played by the agent, and the game currently being operated by the user is excluded. For example, when the game server 14 can evaluate the degree of importance of a scene that is being played by the agent and identifies that the relevant scene is a scene with a high degree of importance, the integrated server 16 may give a notification indicating that a game operation by the user is recommended. The integration processing section 312 in the integrated server 16 may apply an effect to the play image of the game for which a game operation by the user is recommended, to tell the user that a game operation by the user is recommended.

The present disclosure has been described above based on the embodiment. A person skilled in the art would recognize that the embodiment is an example, a combination of the constituent elements and processing processes can be modified in various forms, and such modifications also fall within the scope of the present disclosure.

In the embodiment, the integration processing section 312 has been described to combine a plurality of pieces of streaming data directed to the same user into one piece of integrated data, but in a modification, the integration processing section 312 may combine a plurality of pieces of streaming data directed to the same user into two or more pieces of integrated data. For example, when receiving two pieces of integrated data, the information processing device 10 may display one piece of integrated data on the output device 4 and display the other piece of integrated data on the terminal device 5. For example, the display processing section 116 may display the play image of a game that is generated according to a game operation performed by the user on the output device 4 and the play image of a game that is generated according to a game operation performed by the agent of the user on the terminal device 5.

In the embodiment, the integration processing section 312 integrates the play images of the games that are played by the user and the agent in real time, but the integration processing section 312 may instead integrate the play images of a game that has been played by the agent in the past. In this instance, the integration processing section 312 may fast-forward the past play images and include the past play images in the integrated data. The game server 14 may record the details of the past play performed by the agent, and the user may be able to start the game from a desired time point in the past play performed by the agent.

In the embodiment, the integrated server 16 integrates the play images generated by the plurality of game servers 14, but in the modification, the information processing device 10 may have the function of integrating the play images generated by the plurality of game servers 14. In this case, the information processing device 10 has the function of receiving the play images generated by the plurality of game servers 14 and integrating the play images. That is, the information processing device 10 may have the functions of the data acquiring section 310 and the integration processing section 312, for example, of the integrated server 16.

Moreover, in the embodiment, the game server 14 generates play images by executing the game program, but in the modification, the information processing device 10 may have the function of generating play images by executing the game program. In this case, the information processing device 10 may have the functions of the operation information receiving section 210, the game play controller 212, the instruction receiving section 214, and the game execution section 216, for example, of the game server 14.

### INDUSTRIAL APPLICABILITY

The present disclosure can be used for a technology of displaying images of a game played by the agent.

### REFERENCE SIGNS LIST

1: Information processing system
10: Information processing device
12: Server system
14: Game server
16: Integrated server
18: Management server
100: Processing section
102: Communication section
110: Operation information receiving section
112: Instruction receiving section
114: Data acquiring section
116: Display processing section
130: Operation information transmitting section
132: Instruction transmitting section
150: Frame
152: Additional information
200: Processing section
202: Communication section
210: Operation information receiving section
212: Game play controller
214: Instruction receiving section
216: Game execution section
218: Streaming data transmitting section
300: Processing section
302: Communication section
310: Data acquiring section
312: Integration processing section
314: Integrated data transmitting section

1. An information processing device comprising:
one or more processors including hardware, wherein
the one or more processors
display a play image of a first game that is generated according to a game operation performed by a user, and
display a play image of a second game that is generated according to a game operation performed by an agent of the user.

2. The information processing device according to claim 1, wherein
the one or more processors
display the play image of the first game in a first display area of a first display device, and
display the play image of the second game in a second display area of the first display device.

3. The information processing device according to claim 1, wherein
the one or more processors
display the play image of the first game on a first display device, and
display the play image of the second game on a second display device.

4. The information processing device according to claim 1, wherein
the one or more processors
receive an instruction for switching a game to be played by the user,
display a play image of the second game that is generated according to the game operation performed by the user, and
display a play image of the first game that is generated according to the game operation performed by the agent of the user.

5. The information processing device according to claim 4, wherein
the one or more processors receive the instruction for switching a game, according to a detected line of sight of the user.

6. The information processing device according to claim 1, wherein
the one or more processors
receive a player change instruction for having the agent perform the game operation for the first game, and
display a play image of the first game that is generated according to the game operation performed by the agent of the user.

7. The information processing device according to claim 1, wherein
the user plays the first game with an agent of another user.

8. The information processing device according to claim 1, wherein
the one or more processors display a play image for which a game operation by the user is recommended, in a mode different from those for other play images.

9. The information processing device according to claim 1, wherein
the one or more processors
display the play image of the first game in a first mode, and
display the play image of the second game in a second mode different from the first mode.

10. The information processing device according to claim 1, wherein
the one or more processors
display a play image of a game that is generated according to the game operation performed by the user, based on a first viewpoint, and
display a play image of a game that is generated according to the game operation performed by the agent of the user, based on a second viewpoint different from the first viewpoint.

11. A game image display method of displaying a play image of a game in an information processing device, comprising:
displaying a play image of a first game that is generated according to a game operation performed by a user; and
displaying a play image of a second game that is generated according to a game operation performed by an agent of the user.
